(19) United States
(12) Patent Application Publication
(10) Pub. No.: US 2007/0221630 A1
(43) Pub. Date: Sep. 27, 2007

(54) Steam boiler electrode

(75) Inventor: Curtis J. Diedrick, Knoxville, TN (US)

Correspondence Address: PITTS AND BRITTIAN P C, P O BOX 51295, KNOXVILLE, TN, 37950-1295, US

(73) Assignee: Precision Boilers, Inc.

(21) Appl. No.: 11/386,415

(22) Filed: Mar. 22, 2006

(51) Int. Cl. B23K 9/00

(52) U.S. Cl. 219/121.5

(57) ABSTRACT

An apparatus is provided for preventing arcing in an electrode steam boiler including a nozzle directing water toward a primary electrode. The electrode includes a strike plate and at least one side edge portion. The apparatus comprises a non-conductive covering located on the side edge portion between the nozzle and the edge portion. Water directed by the nozzle into contact with the non-conductive covering will not allow arcing from the nozzle to the electrode.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to electrode boilers.

More particularly, this invention pertains to electrodes which are partially covered with a non-conducting material to prevent arcing.

2. Description of the Related Art

Electrode boilers use high voltage electricity as the fuel to generate steam. Using boiler water as a resistor between electrodes at a constant voltage, heat is generated by the relation of P=I²R(1.732 (or also known as P=IE(1.732). Using this constant, the boiler creates steam by resistance heating of the water contained within the boiler. Common knowledge is that arcing provides the heating energy. To the contrary, arcing does not provide the most efficient transfer of energy and is detrimental to both the boiler and the power delivery system.

In an electrode boiler, water is circulated by a circulation pump located within a lower region of the boiler chamber or in a location near to the boiler and piped into the boiler chamber. The boiler includes a reservoir of water that is available for conversion to steam. Water is removed from the reservoir by an impeller and discharged into piping in flow communication with a boiler nozzle header. Water is then urged laterally outward from nozzles mounted on the header and falls under the influence of gravity, directed toward the first electrodes in laminar streams. After striking the primary electrodes, and absorbing the primary electrical energy available from the primary energy source to create steam, the water is channeled over a non-conducting space from the primary electrodes to a secondary electrode located below the primary electrode. The resistance of the water raises the energy of the water to create steam.

After the water has contacted the secondary electrode, the remaining water, absent the energized steam, is returned to the boiler reservoir for additional heating to create additional steam.

In a standard electrode boiler, flow to the electrodes is regulated by a variable speed drive of the circulation pump(s), which control the relative flow of water in accordance with the demand for steam. As more steam is required by the steam system, the pump speed increases to provide additional water flow to the nozzle head. Accordingly, there is an increasing flow from the nozzles to the electrodes. An increasing number of nozzle flows to the electrodes provides a greater number of paths for current and a consequent reduction in the total resistance between each electrode phase and neutral. (Current paths are in parallel.)

The transfer of heat energy is produced by resistance, in contrast to arcing. Typically, about 3% of the total flow of water that flows from the primary electrode to the secondary electrode is evaporated to steam. The remaining heated water falls under the influence of gravity to the boiler reservoir.

The boiler output is a function of the spacing between the nozzle header and the primary electrode, the distance between the primary electrode and the secondary electrode, the speed of flow of the water, voltage applied, and the conductivity of the water. Boiler water conductivity is an important aspect of electrode boiler treatment programs.

In the operation of an electrode boiler, water is pumped from a nozzle toward a vertically oriented, elongated primary electrode which is generally C-shaped in cross-section. The side edges of the primary electrode are scrolled inwardly to capture the water sprayed by the nozzle against the back inner wall of the primary electrode. The primary electrode is maintained at potential of approximately 8 kilovolts from the nozzle. It is the resistance of the water which generates the heat to create steam. There is no high temperature transfer across tube walls with locally high temperature. No part of the electrode boiler is subjected to temperatures greater than the saturation temperature of the steam pressure being developed. Consequently, scaling is reduced substantially and is of less concern, except that scale can build up in the nozzles, obstructing flow. The energy input is electrical and the water is the conductor of the electricity from a primary electrode to a secondary electrode. Accordingly, the water conductivity and contaminants are important. It is desirable to minimize particulate matter, such as the magnetite form of iron oxide in the water, in order to reduce the erosion of the nozzles and other flow components.

Over a period of time, scale will accumulate in the nozzle, disrupting the generally laminar flow of the water from the nozzle to the electrode. When the flow is disrupted, it spreads toward the edges of the primary electrode and creates an arcing effect. Arcing is detrimental to boiler operation and also can disrupt the power on the transmission line and adversely affect office equipment sharing the power transmission line. It is therefore desirable to reduce or eliminate the opportunity for arcing within an electrode boiler.

### BRIEF SUMMARY OF THE INVENTION

In another embodiment the non-conductive material may be sprayed onto the edges of the primary electrode.

According to one embodiment of the present invention, an apparatus for preventing arcing in an electrode steam boiler includes a nozzle directing water toward a primary electrode. The electrode includes a strike plate and at least one side edge portion. A non-conductive covering is located on the side edge portion between the nozzle and the edge portion. The non-conductive covering may comprise silicone or polytetrafluoroethylene, for example. When water is directed by the nozzle into contact with the non-conductive covering arcing will not occur between the nozzle and the electrode. The non-conductive covering may comprise a sheet of non-conductive material secured to the primary electrode, either mechanically or with adhesive. In another embodiment the non-conductive material may be sprayed onto the edges of the primary electrode.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is an elevation view of a primary electrode embodying various features of the present invention;

FIG. 2 is a sectional view taken along line 2-2 of FIG. 1; and

FIG. 3 is a plan sectional view of an electrode boiler.

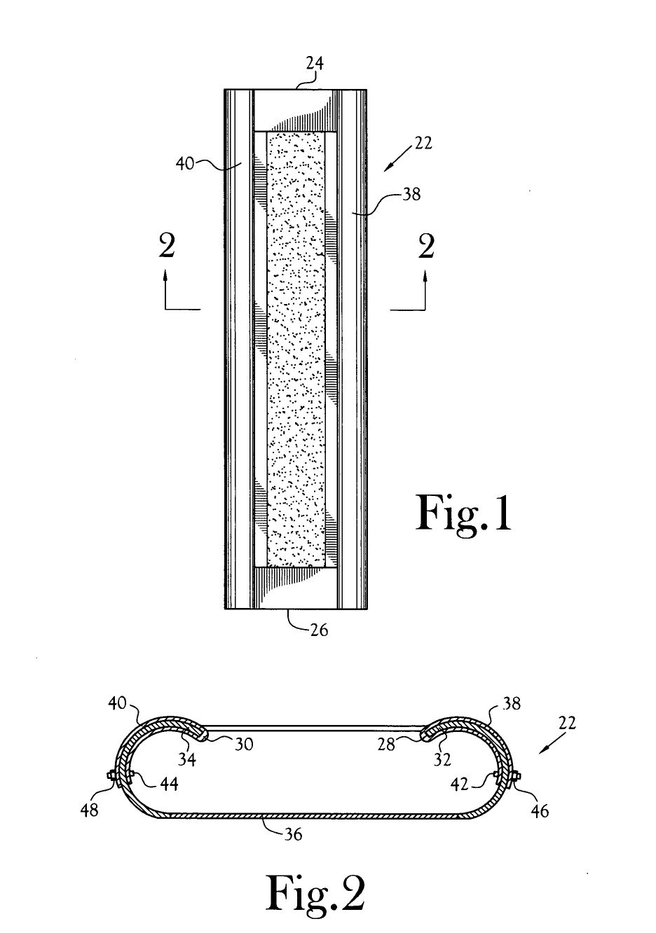

### DETAILED DESCRIPTION OF THE INVENTION

Referring to the drawings, in which like-numbered parts represent similar parts, an apparatus for the reduction of arcing in an electrode boiler is disclosed.

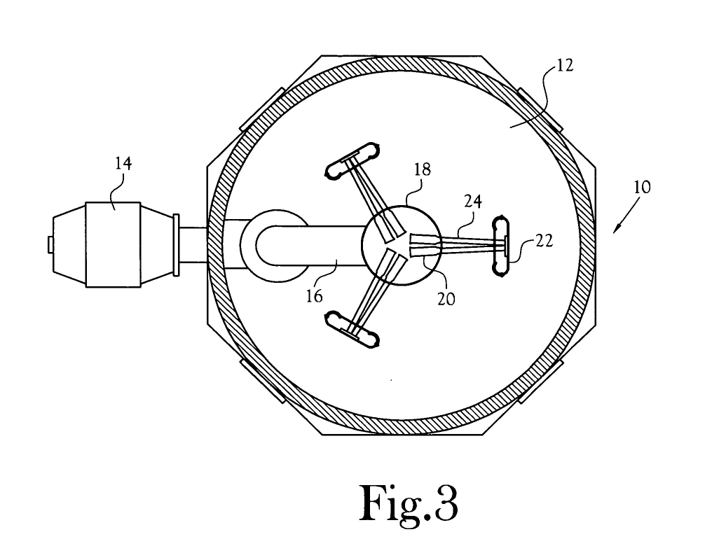

The electrode boiler 10 represented in FIG. 3 includes a sealed reservoir 12. In the center of the reservoir 12 is a supply header 18 which supplies water to a plurality of nozzles 20 directed outwardly from the supply header toward a plurality of primary electrodes 22. The primary electrodes are generally identical. Accordingly only one primary electrode will be described in detail.

The primary electrode 22 is elongated, having a top edge 24, a bottom edge 26, a first side edge 28 and a second side edge 30. The primary electrode 22 is generally C-shaped in cross-section. The first edge portion 32 adjacent to the first edge 28 and the second edge portion 34 adjacent to the second edge 30 are scrolled inwardly to prevent splashing of water outwardly from the strike plate 36 of the electrode 22.

A sheet 38, comprising a non-conductive material, such as polytetrafluoroethylene or silicone, for example, is secured over the edge portion 32, substantially from the top edge 24 to the bottom edge 26. Similarly, a sheet 40 comprising a non-conductive material, such as polytetrafluoroethylene or silicone, for example, is secured over the edge portion 34, substantially from the top edge 24 to the bottom edge 26.

Polytetrafluoroethylene is a satisfactory material for use in boilers having temperatures of less than about 400 degrees Fahrenheit and pressures of less than about 250 psi. In boilers having temperatures is excess of about 400 degrees Fahrenheit and pressures in excess of about 250 psi, silicone is a preferred material. It will be recognized by those skilled in the art that other non-conductive materials may be used, provided that they can withstand the conditions within the electrode steam boiler 10.

In the depicted embodiment, the sheet 38 is secured to the edge portion 32 with a plurality of bolts 42 and nuts 46. Similarly, the sheet 40 is secured to the edge portion 34 with a plurality of bolts 44 and nuts 48. As desired, other securing means, such as adhesives or brackets may be used to secure the sheets 38 and 40 in place. Alternatively, a non-conductive layer of material, such as polytetrafluoroethylene or silicone, for example, may be sprayed onto the edge portions, provided that the bond between the non-conductive layer and the surface of the electrode 22 is sufficiently strong to withstand the elevated temperatures and pressures within the electrode steam boiler 10.

In operation, as scale may accumulate in the outboard end of the nozzle 20, a portion of the water stream traveling from the nozzle 20 to the electrode 22, may be directed away from the strike plate 36 and toward one or both of the edge portions 32 and 34. The non-conductive covering on the edge portions 32 and 34 prevent arcing from the nozzle to the edge portions 32 and 34.

Those skilled in the art will recognize that a variety of non-conductive materials may be used to cover the edge portions to prevent arcing from the nozzles to the electrodes without departing from the spirit and scope of the present invention.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for preventing arcing in an electrode steam boiler including a nozzle directing water toward a primary electrode, said electrode including a strike plate and at least one side edge portion, said apparatus comprising:
a non-conductive covering located on said side edge portion between said nozzle and said edge portion,
whereby water directed by said nozzle into contact with said non-conductive covering will not allow arcing from said nozzle to said electrode.

2. The apparatus of claim 1 wherein said non-conductive covering comprises a sheet of non-conductive material secured to said primary electrode.

3. The apparatus of claim 1 wherein said covering comprises silicone.

4. The apparatus of claim 1 wherein said covering comprises polytetrafluoroethylene.

5. The apparatus of claim 1 wherein said covering comprises a coating applied to said edge portion.

6. An apparatus for preventing arcing in an electrode steam boiler including a nozzle directing water toward a primary electrode, said electrode including a strike plate and at least one scrolled side edge portion, said apparatus comprising:
a non-conductive covering located on said side edge portion between said nozzle and said edge portion,
whereby water directed by said nozzle into contact with said non-conductive covering will not allow arcing from said nozzle to said scrolled edge portion of said electrode.

7. The apparatus of claim 5 wherein said non-conductive covering comprises a sheet of non-conductive material secured to said primary electrode.

8. The apparatus of claim 5 wherein said covering comprises silicone.

9. The apparatus of claim 5 wherein said covering comprises polytetrafluoroethylene.

10. The apparatus of claim 5 wherein said covering comprises a coating applied to said edge portion.

11. An apparatus for preventing arcing in an electrode steam boiler including a nozzle directing water toward a primary electrode, said electrode being generally C-shaped in cross-section, including a central strike plate, a first scrolled side edge portion and a second opposing side edge portion, said apparatus comprising:
a non-conductive covering located on said first and second scrolled side edge portions between said nozzle and said scrolled side edge portions,
whereby water directed by said nozzle into contact with said non-conductive covering will not allow arcing from said nozzle to said electrode.

12. The apparatus of claim 9 wherein said non-conductive covering comprises a sheet of non-conductive material secured to said primary electrode.

13. The apparatus of claim 9 wherein said covering comprises silicone.

14. The apparatus of claim 9 wherein said covering comprises polytetrafluoroethylene.

15. The apparatus of claim 9 wherein said covering comprises a coating applied to said edge portion.
